(19) United States
(12) Patent Application Publication
(10) Pub. No.: US 2003/0114611 A1
(43) Pub. Date: Jun. 19, 2003

(54) Functionalized alkyllithium formulations with improved thermal stability and processes for making the same

(75) Inventors: Thorsten Werner Brockmann, Gastonia, NC (US); Vijay C. Mehta, Gastonia, NC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: FMC Corporation

(21) Appl. No.: 10/004,261

(22) Filed: Oct. 24, 2001

(51) Int. Cl. C08F 4/56; C07F 1/02; C07F 3/02

(52) U.S. Cl. 526/174; 260/665 R; 260/665 G

(57) ABSTRACT

Formulations of functionalized alkyllithium species having improved thermal stability are provided. The compositions include one or more functionalized alkyllithium compounds and one or more additives. The additive includes one or more organometallic compounds or precursors thereof capable of forming ate complexes with alkyllithiums.

### FIELD OF THE INVENTION

This invention relates to functionalized alkyllithium compositions, and more particularly to thermally stable functionalized alkyllithium compositions and processes for making the same.

### BACKGROUND OF THE INVENTION

Alkyllithium compounds have found increasing use as anionic initiators in polymer chemistry, and as reagents in organic synthesis. Typically, alkyllithium compounds are supplied commercially in hydrocarbon solution, such as hexane or cyclohexane.

Alkyllithium compounds decompose by thermal elimination of lithium hydride, with concurrent formation of the corresponding olefin. The decomposition of normal butyllithium is illustrated in equation I.

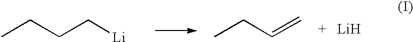

The lithium hydride is virtually insoluble in this medium, and precipitates from solution. This precipitation can cause pluggage of butyllithium pipes and transfer lines. Further, safety and environmental problems can arise when the clogged lines are cleared. In addition, the co-product of this degradation, 1-butene, is a flammable gas. Thus, the thermal stability of these alkyllithium compounds is of importance, particularly on a commercial scale.

Several factors influence the rate of thermal degradation, including: the identity of the alkyllithium compound, the concentration of the solution, the identity of the solvent, the temperature, and the nature of the impurities present, particularly alkoxides. The alkyllithium decomposition rate can be measured by the decline in the active carbon-lithium species, as determined by titration. Various titrametric methods are collected in B. J. Wakefield, Organolithium Methods, Academic Press, New York, 1988, 16-18. Thermal decomposition data for normal butyllithium (n-C₄H₉Li) and secondary butyllithium (s-C₄H₉Li) in hydrocarbon solvents is collected in the table below. The decomposition rate is shown to increase with an increase in storage temperature, and an increase in the concentration of the alkyllithium. Further, secondary butyllithium is less stable than normal butyllithium at all temperatures. For additional discussion of the thermal decomposition of alkyllithium reagents, see M. Schlosser, Organometallics in Synthesis, A Manual, John Wiley, New York, 1994, 171-173.

DECOMPOSITION RATES (% Material Lost per Day)

| | | | s-C₄H₉—Li |
|---|---|---|---|
| Storage | n-C₄H₉—Li | n-C₄H₉—Li | 10-12% in |
| Temperature (° C.) | 15-20% in hexane | 90% in hexane | isopentane |
| 0 | 0.00001 | 0.0005 | 0.003 |
| 5 | 0.0002 | 0.0011 | 0.006 |
| 10 | 0.0004 | 0.0025 | 0.012 |
| 20 | 0.0018 | 0.013 | 0.047 |
| 35 | 0.017 | 0.11 | 0.32 |

The addition of a Lewis base enhances the rate of decomposition of an alkyllithium compound. For instance, n-butyllithium is completely decomposed in tetrahydrofuran at room temperature within two hours, see H. Gilman and B. J. Gaj, J. Org. Chem., 22, 1165 (1957). The alkyllithium compound can also react with the Lewis base; this reaction is illustrated in equation II for the interaction of n-butyllithium with tetrahydrofuran.

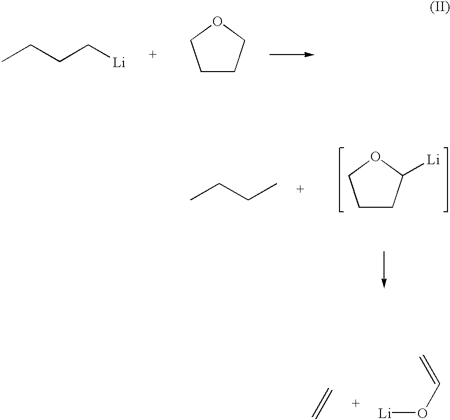

The tetrahydrofuran is initially deprotonated with the n-butyllithium, alpha to the oxygen atom, to afford n-butane. The metallated tetrahydrofuran then decomposes to ethylene and the enolate of acetaldehyde. Similar decomposition pathways exist for the interaction of other alkyllithium species with various Lewis bases. For instance, the half life of t-butyllithium in dimethoxyethane is only eleven minutes at −70° C. See J. J. Fitt and H. W. Gschwend, J. Org. Chem., 49, 209, (1984). For a further discussion of the interaction of alkyllithium compounds with Lewis bases, see H. L. Hsieh and R. P. Quirk, Anionic Polymerization, Marcel Dekker, Inc., New York, 1996, 102-103.

U.S. Pat. No. 6,103,846 to Willis et al. is directed to a process of anionic polymerization using protected functionalized initiators of the structure R¹R²R³—Si—A—B, wherein each R¹, R², and R³ is independently selected from saturated and unsaturated aliphatic and aromatic radicals, A is a hydrocarbon bridging group containing from 1 to 25 carbon atoms, and B is an alkali metal, such as lithium. More particularly, the Willis et al. patent is directed to a polymerization process conducted in the presence of termination inhibitors selected to inhibit the reactivity of such protected functionalized initiators towards undesired side reactions. The inhibitors include metal alkyl compounds.

Willis et al. state at Column 5, lines 20 to 23, that “[i]t is unlikely that levels below one inhibitor per 10 C—Li chain ends (Metal Alkyl/C—Li Center >0.1) give a measurable level of inhibition of the side reaction with the Si—O centers.” Thus the Willis et al. patent indicates that at least 10 mole percent metal alkyl is necessary to achieve the desired reactivity inhibition. Preferred levels of the alkyl metal are stated to range from 50 mole % to 100 mole %, and the examples demonstrate the use of 100 mole % triethylaluminum (TEA).

Hsieh and Quirk, referenced above, discuss the effect of organometallic compounds of different metals with alkyllithiums. See pages 143-146 of H. L. Hsieh and R. P. Quirk, Anionic Polymerization, Marcel Dekker, Inc., New York, 1996. For example, addition of increasing amounts of dibutylmagnesium to a constant amount of sec-butyllithium in cyclohexane was reported to reduce the rate of styrene or butadiene polymerization and decrease molecular weight without significantly broadening molecular weight distribution or changing the polybutadiene microstructure. See page 145 of Hsieh and Quirk, referencing H. L Hsieh and I. W. Wang, Macromolecules, 19, 299 (1986). Thus the dibutylmagnesium slows, or inhibits, polymerization rates to better control polymer molecular weight distribution and microstructure. Generally, dibutylmagnesium is used in an amount effective to inhibit the polymerization rate to achieve this effect, or about a 1:1 molar ratio (or 100 mole % dibutylmagnesium). Even for complexes of alkyllithiums and diethylzinc, reported to increase the rate of initiation for polymerization of butadiene and styrene, diethylzinc is generally used in 1:1 molar ratios, or 100% molar %.

This inhibiting effect of an organometallic compound, such as triethylaluminum, upon polymerization reactions is illustrated by U.S. Pat. No. 5,514,753 to Ozawa et al. The Ozawa et al. patent is directed to a process for preparing block copolymers that include a non-polar block (such as a polybutadiene or polystyrene block) and a polar block (such as a poly t-butylmethacrylate block). In Ozawa et al., a non-polar block is prepared by anionically polymerizing a non-polar monomer using a suitable initiator such as butyllithium. The resultant non-polar block with a living lithium end is then reacted with a polar monomer in the presence of an organic compound containing a main group element of II or III group metals, such as triethylaluminum.

Adding triethylaluminum or other suitable agent lowers the reactivity of the carbanion at the living polymer end towards a polar monomer so as to provide the desired polymer microstructure. The amount of organic compound used is stated to range from about 0.5 to 10 mole equivalents per 1 mol equivalent of anionic polymerization initiator (or about 50 to 1000 mole %). See Column 6, lines 19-21. As further stated in the Ozawa et al. patent, “[i]f the amount is less than 0.5 mole equivalent per 1 mole of initiator, the effect might not be significant . . . ” See Column 6, lines 23-25. Thus, again the art demonstrates that such organometallic compounds are used in relatively large mole percentages in order to inhibit reactivity of the carbanion, and thus slow down polymerization rates.

### SUMMARY OF THE INVENTION

The present invention provides compositions of protected functionalized alkyllithium compounds that exhibit improved thermal stability as compared to prior protected functionalized alkyllithium compositions. The protected functionalized alkyllithium compositions include one or more thermal stabilizing organometallic additives. Surprisingly the inventors have found that relatively small amounts of the organometallic additive can provide unexpected benefits such as improved thermal stability, increased yields of the alkyllithium product, and the like. Yet the presence of the organometallic compound does not significantly adversely compromise the reactivity of the alkyllithium species, for example, as anionic polymerization initiators.

The organometallic compounds are generally used in an amount sufficient to thermally stabilize the lithiated species without significantly inhibiting or compromising the reactivity thereof. Advantageously the organometallic compound is present in an amount less than about 10 mol percent (less than 0.1 molar equivalent), based upon the amount of lithiated species present, although significantly lower levels can be effective in thermally stabilizing the living polymers.

The thermal stabilizing organometallic additives include organometallic compounds that are capable of forming ate complexes with an alkyllithium. Exemplary organometallic compounds that are capable of forming an ate complex with an alkyllithium can be represented by the general formula MetR′ₙ, wherein:

Met is a metal, preferably selected from Group IIA, Group IIB, and Group IIIB of the Periodic Table of Elements;

each R′ is independently selected from linear or branched C1-C20 aliphatic hydrocarbons, C2-C20 cycloaliphatic hydrocarbons, C5-C20 aromatic hydrocarbons, and mixtures thereof; and

n is the valence of Met. One particularly advantageous thermal stabilizing additive is dibutylmagnesium.

The resultant compositions exhibit improved thermal stability and thus reduced alkyllithium degradation. As a result the compositions of the invention can have reduced amounts of insoluble lithium hydride and/or increased amounts of active carbon-lithium species, as compared to identical solutions without an additive. This in turn can minimize many of the problems associated with the use of alkyllithium compositions, such as clogging of pipe and transfer lines, environmental and safety concerns, and the like. In addition, the compositions of the invention can provide cost savings associated with shipping and storage. For example, composition concentrations can be increased without concurrent increase of alkyllithium degradation. Also, the compositions can be more readily shipped and stored without requiring refrigeration. These formulations can also be prepared in higher yields than previously obtained.

As discussed above, U.S. Pat. No. 6,103,846 to Willis et al. states that greater than 10 mole % of the metal alkyl is required to inhibit the reactivity of a polymer. In particular, the Willis et al. patent states that greater than 10 mole % polymerization termination inhibitor is required to inhibit terminating reactions resulting from the reaction of the alkali metal living end of the polymer chain with the —Si—O— bond on the protected end of the polymer chain. Thus, based on the teachings of the Willis et al. patent, it is reasonable to assume that one would not observe polymerization termination inhibition resulting from alkali metal attack of the silicon bond using less than 10 mole % of the metal alkyls described therein. Surprisingly, however, the inventors have found that less than 10 mole % of an organometallic agent can thermally stabilize a monomeric system.

The present invention not only uses less than 10 mole % of the agent. The present invention is also directed to a different system than that described by Willis et al., namely a monomeric system and not a polymeric system. One skilled in the art will appreciate the differences between monomeric systems and polymeric systems, including the different reactivities of such systems.

### DETAILED DESCRIPTION OF THE INVENTION

The novel stabilized compositions of the invention include one or more protected functionalized alkyllithium species and one or more organometallic additives capable of thermally stabilizing the composition. Protected functionalized alkyllithium thermal stabilizing organometallic compounds in accordance with the present invention include organometallic compounds capable of interacting with the alkyllithium to form an ate complex therewith. Advantageously the organometallic compounds are soluble in hydrocarbon solvents, but this is not required.

Organometallic compounds that are capable of forming an ate complex with an alkyllithium can be represented by the general formula MetR′ₙ, wherein:

Met is a metal, preferably selected from Group IIA, Group IIB, and Group IIIB of the Periodic Table of Elements;

each R′ is independently selected from linear or branched C1-C20 aliphatic hydrocarbons, C2-C20 cycloaliphatic hydrocarbons, C5-C20 aromatic hydrocarbons, and mixtures thereof; and

n is the valence of Met.

Thus the organometallic can be described as a compound of the formula M¹R²⁰R²¹ or M²R²³R²⁴R²⁵ wherein M¹ is an element of Group IIA or Group IIB, M² is an element of Group IIIB, and each R²⁰, R²¹, R²³, R²⁴, and R²⁵ is independently selected from the group consisting of linear or branched C1-C20 aliphatic hydrocarbons, C2-C20 cycloaliphatic hydrocarbons, C5-C20 aromatic hydrocarbons, and mixtures thereof. The Group IIA and IIB elements include beryllium, magnesium, calcium, strontium, barium, radium, zinc, cadmium, and mercury. The Group IIIB elements include boron, aluminum, gallium, indium, and thallium. Exemplary organometallic compounds include without limitation diethylmagnesium, diisopropylmagnesium, dibutylmagnesium, dicyclohexylmagnesium, diphenylmagnesium, diethylzinc, dibutylzinc, diphenyl zinc, triethylaluminum, tripropylaluminum, triisopropylaluminum, tributylaluminum, trioctylaluminum, trimethylboron, triethylboron, and tributylboron and the like and mixtures thereof. As used herein, the term “butyl” includes n-butyl, sec-butyl and iso-butyl. Also as used herein the term linear or branched aliphatic hydrocarbons, cycloaliphatic hydrocarbons and aromatic hydrocarbons include functionalized hydrocarbons, including one or more sulfur, nitrogen and/or oxygen atoms.

These and other additives within the scope of this invention are commercially available or can be synthesized using commercially available starting materials using known procedures.

Exemplary protected functionalized alkyllithium compounds include compounds of the formula (I) or (II)

Li—Qₙ—Z—T—(A—R₁₀R₁₁R₁₂)ₘ (I)

and

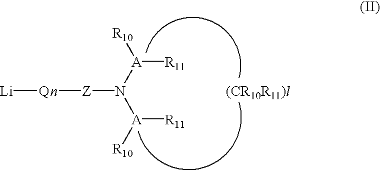

wherein:

Q is a saturated or unsaturated hydrocarbyl group derived by incorporation of one or more conjugated diene hydrocarbons, one or more alkenylaromatic compounds, or mixtures of one or more dienes with one or more alkenylaromatic compounds into the M—Z linkage;

n is from 0 to 5;

Z is a branched or straight chain hydrocarbon connecting group which contains 3-25 carbon atoms, optionally substituted with C5-C25 aryl or substituted C5-C25 aryl;

T is selected from the group consisting of oxygen, sulfur, and nitrogen groups and mixtures thereof;

(A—R₁₀R₁₁R₁₂)ₘ is a protecting group in which A is an element selected from Group IVa of the Periodic Table of the Elements, and R₁₀, R₁₁, and R₁₂ are each independently selected from the group consisting of hydrogen, C1-C15 alkyl, substituted C1-C15 alkyl, C5-C25 aryl, substituted C5-C25 aryl, C5-C12 cycloalkyl and substituted C5-C12 cycloalkyl;

l is an integer from 1 to 7; and

m is 1 when T is oxygen or sulfur, and 2 when T is nitrogen.

In one advantageous embodiment of the invention, the protected functionalized alkyllithium species includes an alkyl derived protecting group (i.e., those compounds in accordance with the formulas above in which “A” of the protecting group is carbon). Such compounds further advantageously include a protected amino group (in which “T” is nitrogen) or a protected hydroxyl group (in which “T” is oxygen).

In another embodiment of the invention, the protecting group includes a silyl compound (i.e., “A” of the protecting group is silicon). Such compounds further advantageously include a protected amino group (“T” is nitrogen).

Examples of functionalized alkyllithium compounds include, but are not limited to, 3-(t-butyldimethylsilyloxy)-1-propyllithium, 3-(t-butyldimethyl-silyloxy)-2-methyl-1-propyllithium, 3-(t-butyldimethylsilyloxy)-2,2-dimethyl-1-propyllithium, 4-(t-butyldimethylsilyloxy)-1-butyllithium, 5-(t-butyldimethyl-silyloxy)-1-pentyllithium, 6-(t-butyldimethylsilyloxy)-1-hexyllithium, 8-(t-butyldimethylsilyloxy)-1-octyllithium, 3-(t-butyldiphenylsilyloxy)-1-propyllithium, 3-(t-butyldiphenylylsiloxy)-2-methyl-1-propyllithium, 3-(t-butyldiphenylsilyloxy)-2,2-dimethyl-1-propyllithium, 6-(t-butyldiphenylsilyloxy)-1-hexyllithium, 3-(triisopropylsilyloxy)-1-propyllithium, 3-(trimethylsilyloxy)-2,2-dimethyl-1-propyllithium, 3-(triethylsilyloxy)-2,2-dimethyl-1-propyllithium, 3-(1,1-dimethylethoxy)-1-propyllithium, 3-(1,1-dimethylethoxy)-2-methyl-1-propyllithium, 3-(1,1-dimethylethoxy)-2,2-dimethyl-1-propyllithium, 4-(1,1-dimethylethoxy)-1-butyllithium, 5-(1,1-dimethylethoxy)-1-pentyllithium, 6-(1,1-dimethylethoxy)-1-hexyllithium, 8-(1,1-dimethylethoxy)-1-octyllithium, 3-(1,1-dimethylpropoxy)-1-propyllithium, 3-(1,1-dimethylpropoxy)-2-methyl-1-propyllithium, 3-(1,1-dimethylpropoxy)-2,2-dimethyl-1-propyllithium, 4-(1,1-dimethylpropoxy)-1-butyllithium, 5-(1,1-dimethylpropoxy)-1-pentyllithium, 6-(1,1-dimethylpropoxy)-1-hexyllithium, 8-(1,1-dimethylpropoxy)-1-octyllithium, 4-(methoxy)-1-butyllithium, 4-(ethoxy)-1-butyllithium, 4-(n-propyloxy)-1-butyllithium, 4-(1-methylethoxy)-1-butyllithium, 3-[3-(dimethylamino)-1-propyloxy]-1-propyllithium, 3-[2-(dimethylamino)-1-ethoxy]-1-propyllithium, 3-[2-(diethylamino)-1-ethoxy]-1-propyllithium, 3-[2-(diisopropyl)amino)-1-ethoxy]-1-propyllithium, 3-[2-(1-piperidino)-1-ethoxy]-1-propyllithium, 3-[2-(1-pyrrolidino)-1-ethoxy]-1-propyllithium, 4-[3-(dimethylamino)-propyloxy]-1-butyllithium, 6-[2-(1-piperidino)-1-ethoxy]-1-hexyllithium, 3-[2-(methoxy)-1-ethoxy]-1-propyllithium, 3-[2-(ethoxy)-1-ethoxy]-1-propyllithium, 4-[2-(methoxy)-1-ethoxy]-1-butyllithium, 5-[2-(ethoxy)-1-ethoxy]-1-pentyllithium, 3-[3-(methylthio)-1-propyloxy]-1-propyllithium, 3-[4-(methylthio)-1-butyloxy]-1-propyllithium, 3-(methylthiomethoxy)-1-propyllithium, 6-[3-(methylthio)-1-propyloxy]-1-hexyllithium, 3-(N,N-dimethylamino)-1-propyllithium, 3-(N,N-dimethylamino)-2-methyl-1-propyllithium, 3-(N,N-dimethylamino)-2,2-dimethyl-1-propyllithium, 4-(N,N-dimethylamino)-1-butyllithium, 5-(N,N-dimethylamino)-1-pentyllithium, 6-(N,N-dimethylamino)-1-hexyllithium, 3-(N,N-diethylamino)-1-propyllithium, 3-(N,N-diethylamino)-2-methyl-1-propyllithium, 3-(N,N-diethylamino)-2,2-dimethyl-1-propyllithium, 4-(N,N-diethylamino)-1-butyllithium, 5-(N,N-diethylamino)-1-pentyllithium, 6-(N,N-diethylamino)-1-hexyllithium, 3-(N-ethyl-N-methylamino)-1-propyllithium, 3-(N-ethyl-N-methylamino)-2-methyl-1-propyl halide, 3-(N-ethyl-N-methylamino)-2,2-dimethyl-1-propyl halide, 4-(N-ethyl-N-methylamino)-1-butyllithium, 5-(N-ethyl-N-methylamino)-1-pentyllithium, 6-(N-ethyl-N-methylamino)-1-hexyllithium, 3-(piperidino)-1-propyllithium, 3-(piperidino)-2-methyl-1-propyllithium, 3-(piperidino)-2,2-dimethyl-1-propyllithium, 4-(piperidino)-1-butyllithium, 5-(piperidino)-1-pentyllithium, 6-(piperidino)-1-hexyllithium, 3-(pyrrolidino)-1-propyllithium, 3-(pyrrolidino)-2-methyl-1-propyllithium, 3-(pyrrolidino)-2,2-dimethyl-1-propyllithium, 4-(pyrrolidino)-1-butyllithium, 5-(pyrrolidino)-1-pentyllithium, 6-(pyrrolidino)-1-hexyllithium, 3-(hexamethyleneimino)-1-propyllithium, 3-(hexamethyleneimino)-2-methyl-1-propyllithium, 3-(hexamethyleneimino)-2,2-dimethyl-1-propyllithium, 4-(hexamethyleneimino)-1-butyllithium, 5-(hexamethyleneimino)-1-pentyllithium, 6-(hexamethyleneimino)-1-hexyllithium, 3-(2,2,5,5-tetramethyl-2,5-disila-1-azacyclopentane)-1-propyllithium, 4-(2,2,5,5-tetramethyl-2,5-disila-1-azacyclopentane)-1-butyllithium, 6-(2,2,5,5-tetramethyl-2,5-disila-1-azacyclopentane)-1-hexyllithium, 3-(N-isopropyl-N-methyl)-1-propyllithium, 2-(N-isopropyl-N-methyl)-2-methyl-1-propyllithium, 3-(N-isopropyl-N-methyl)-2,2-dimethyl-1-propyllithium, and 4-(N-isopropyl-N-methyl)-1-butyllithium, 3-(methylthio)-1-propyllithium, 3-(methylthio)-2-methyl-1-propyllithium, 3-(methylthio)-2,2-dimethyl-1-propyllithium, 4-(methylthio)-1-butyllithium, 5-(methylthio)-1-pentyllithium, 6-(methylthio)-1-hexyllithium, 8-(methylthio)-1-octyllithium, 3-(methoxymethylthio)-1-propyllithium, 3-(methoxymethylthio)-2-methyl-1-propyllithium, 3-(methoxymethylthio)-2,2-dimethyl-1-propyllithium, 4-(methoxymethylthio)-1-butyllithium, 5-(methoxymethylthio)-1-pentyllithium, 6-(methoxymethylthio)-1-hexyllithium, 8-(methoxymethylthio)-1-octyllithium, 3-(1,1-dimethylethylthio)-1-propyllithium, 3-(1,1-dimethylethylthio)-2-methyl-1-propyllithium, 3-(1,1-dimethylethylthio)-2,2-dimethyl-1-propyllithium, 4-(1,1-dimethylethylthio)-1-butyllithium, 5-(1,1-dimethylethylthio)-1-pentyllithium, 6-(1,1-dimethylethylthio)-1-hexyllithium, 8-(1,1-dimethylethylthio)-1-octyllithium, 3-(1,1-dimethylpropylthio)-1-propyllithium, 3-(1,1-dimethylpropylthio)-2-methyl-1-propyllithium, 3-(1,1-dimethylpropylthio)-2,2-dimethyl-1-propyllithium, 4-(1,1-dimethylpropylthio)-1-butyllithium, 5-(1,1-dimethylpropylthio)-1-pentyllithium, 6-(1,1-dimethylpropylthio)-1-hexyllithium, 8-(1,1-dimethylpropylthio)-1-octyllithium, 3-(cyclopentylthio)-1-propyllithium, 3-(cyclopentylthio)-2-methyl-1-propyllithium, 3-(cyclopentylthio)-2,2-dimethyl-1-propyllithium, 4-(cyclopentylthio)-1-butyllithium, 5-(cyclopentylthio)-1-pentyllithium, 6-(cyclopentylthio)-1-hexyllithium, 8-(cyclopentylthio)-1-octyllithium, 3-(cyclohexylthio)-1-propyllithium, 3-(cyclohexylthio)-2-methyl-1-propyllithium, 3-(cyclohexylthio)-2,2-dimethyl-1-propyllithium, 4-(cyclohexylthio)-1-butyllithium, 5-(cyclohexylthio)-1-pentyllithium, 6-(cyclohexylthio)-1-hexyllithium, 8-(cyclohexylthio)-1-octyllithium, 3-(t-butyldimethylsilylthio)-1-propyllithium, 3-(t-butyldimethylsilylthio)-2-methyl-1-propyllithium, 3-(t-butyldimethylsilylthio)-2,2-dimethyl-1-propyllithium, 3-(t-butyldimethylsilylthio)-2-methyl-1-propyllithium, 4-(t-butyldimethylsilylthio)-1-butyllithium, 6-(t-butyldimethylsilylthio)-1-hexyllithium and 3-(trimethylsilylthio)-2,2-dimethyl-1-propyllithium, and the like and mixtures thereof. The chain extended analogues of these functionalized alkyllithium compounds can also be employed.

In other advantageous embodiments of the invention, the protected functionalized alkyllithium compound can be include a tertiary amine functionality having two protecting groups, which may be the same or different. When the protecting groups are different, the groups are selected so as to have differential stability under specified deprotection conditions. Accordingly one of the protecting groups can be selectively removed without removing the other protecting group.

Such compounds include those of the formula (III):

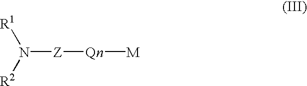

wherein:

M is an alkali metal selected from the group consisting of lithium, sodium and potassium;

Z is a branched or straight chain hydrocarbon connecting group which contains 3-25 carbon atoms, optionally substituted with aryl or substituted aryl;

Q is a saturated or unsaturated hydrocarbyl group, and can be derived by the incorporation of one or more unsaturated organic compounds, such as one or more compounds selected from the group consisting of conjugated diene hydrocarbons, alkenylsubstituted aromatic compounds, and mixtures thereof, into the M—Z linkage;

n is from 0 to 5;

R¹ is a protecting group selected from the group consisting of aralkyl, preferably benzyl or benzyl derivative, allyl, tertiary alkyl, preferably tertiary butyl, and methyl; and

R² can be the same as R¹, with the proviso that when R¹ is methyl, R² is not C1-C4 alkyl, or R² can be different from R¹, in which case R² is selected from the group consisting of alkyl, substituted alkyl, alkoxy, substituted alkoxy, aryl, substituted aryl, heteroaryl, substituted heteroaryl, cycloalkyl, substituted cycloalkyl, heterocycloalkyl, and substituted heterocycloalkyl, with the proviso that when R² is not the same as R¹, then R² is more stable under conditions used to remove R¹,

or R¹ and R² together with the nitrogen atom to which they are attached form

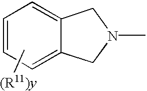

wherein y is from 1 to 4 and each R¹¹ is independently selected from the group consisting of hydrogen, alkyl, substituted alkyl, aryl, substituted aryl, cycloalkyl, substituted cycloalkyl, alkoxy, substituted alkoxy, heteroaryl, substituted heteroaryl, heterocycloalkyl, and substituted heterocycloalkyl.

The term “aralkyl” generally refers to aralkyl groups in which the total number of carbon atoms is no greater than about 18. The term aralkyl includes groups in which the alkylene chain and/or the aryl ring can include one or more heteroatoms, such as oxygen, nitrogen and sulfur. The alkylene chain and/or aryl ring can also be substituted with one or more groups such as C1-C4 alkyl, C1-C4 alkoxy, and the like, so long as the group does not interfere with the functionality of the benzyl protecting group and its removal, and/or with the activity of the lithium end of the compound.

Advantageous aralkyl groups in accordance with the invention are benzyl groups and benzyl derivatives. Benzyl derivatives include groups in which the phenyl ring is substituted with one or more groups such as C1-C4 alkyl, C1-C4 alkoxy, and the like, so long as the group does not interfere with the functionality of the benzyl protecting group and its removal, and/or with the activity of the lithium end of the compound. The term benzyl derivative also refers to benzyl groups in which the methylene linkage may also be substituted, for example, with one or more groups such as C1-C4 alkyl, C1-C4 alkoxy, aryl (phenyl) and the like, again so long as the group does not interfere with the functionality of the benzyl protecting group and its removal, and/or with the activity of the lithium end of the compound. Benzyl derivatives also include groups in which the ring and/or methylene chain can include heteroatoms, such as oxygen, sulfur or nitrogen. Such substituted benzyl protecting groups can be represented by the general formula:

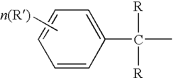

in which n is from 1 to 5; and each R and R′ is independently selected from the group consisting of hydrogen, alkyl, substituted alkyl, aryl, substituted aryl, cycloalkyl, substituted cycloalkyl, alkoxy, substituted alkoxy, heteroaryl, substituted heteroaryl, heterocycloalkyl, substituted heterocycloalkyl, and the like, or at least one R in combination with the phenyl ring forms a cyclic or bicyclic structure, such as

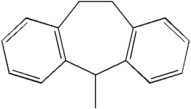

Exemplary R and R′ groups include without limitation methoxy, phenyl, methoxyphenyl, and the like. Exemplary substituted benzyl substituents include without limitation 4-methoxybenzyl, 2,4-dimethoxybenzyl, diphenylmethyl, 4-methoxyphenylmethyl, triphenylmethyl, (4-methoxylphenyl)diphenylmethyl, and the like.

In especially advantageous compounds of formula (III), the protecting group R¹ is aralkyl, preferably benzyl or a benzyl derivative; allyl; or tertiary alkyl, preferably tertiary butyl. In this aspect of the invention, advantageously R² is the same as R¹. Alternatively, in this aspect of the invention, R² is methyl. Examples of such compounds include without limitation 3-[(N-benzyl-N-methyl)amino]-1-propyllithium, 3-[(N,N-dibenzyl)amino]-1-propyllithium, 3-[(N-tert-butyl-N-methyl)amino]-1-propyllithium, 3-[(N,N-di-tert-butyl)amino]-1-propyllithium, and mixtures thereof.

In yet another embodiment of the invention, the protected functionalized alkyllithium compound can include compounds represented generally by the following structure (IV):

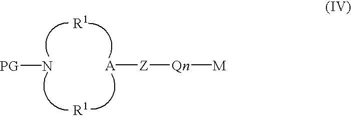

wherein:

M is an alkali metal selected from the group consisting of lithium, sodium and potassium;

Z is a branched or straight chain hydrocarbon connecting group which contains 3-25 carbon atoms, optionally substituted with aryl or substituted aryl;

Q is a saturated or unsaturated hydrocarbyl group, and can be derived by the incorporation of one or more unsaturated organic compounds, such as one or more compounds selected from the group consisting of conjugated diene hydrocarbons, alkenylsubstituted aromatic compounds, and mixtures thereof, into the M—Z linkage;

n is from 0 to 5;

A is N, P, CR or SiR, wherein R is selected from the group consisting of H and saturated or unsaturated aliphatic and aromatic radicals;

each R¹ is independently selected from the group consisting of alkylene and substituted alkylene; and

PG is a protecting group, with the proviso that when A is —CR, then Z, Qn, or both, can be absent.

As used herein the term “alkylene” refers to C1-C10 alkylene. The term “substituted alkylene” refers to C1-C10 alkylene which is substituted with one or more heteroatoms (such as silyl-, amino- and oxy-substituted alkylene chains). Substituted alkylene also refers to C1-C10 alkylene having one or more substituents, such as but not limited to alkyl, substituted alkyl, cycloalkyl, substituted cycloalkyl, heterocycloalkyl, substituted heterocycloalkyl, alkoxy, substituted alkoxy, aryl, substituted aryl, heteroaryl, and substituted heteroaryl. The resultant ring is typically saturated, but the present invention includes unsaturated, non-aromatic ring structures as well.

As noted above, when A is P, CR or SiR, then the tether or connecting group “Z” and/or the chain extension Qn can be absent. However, when “A” is N, then at least the tether “Z” is present.

R can be any suitable monovalent organic radical, and in particular, hydrogen or a saturated or unsaturated aliphatic and aromatic radical. Exemplary saturated or unsaturated aliphatic and aromatic radicals include without limitation alkyl, substituted alkyl, aryl, substituted aryl, cycloalkyl, substituted cycloalkyl, alkoxy, substituted alkoxy, heteroaryl, substituted heteroaryl, heterocycloalkyl, substituted heterocycloalkyl, and the like. The referenced to “substituted” radicals includes substituents such as those described above with reference to the alkylene groups.

Particularly advantageous are compounds in which A is nitrogen and the resultant ring

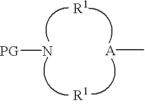

is a five or six membered heterocyclic radical, such as a piperazine ring.

The term “PG” refers to any types of organic substrates stable in the presence of an alkali metal but can be removed under selected conditions. Exemplary protecting groups include without limitation aralkyl, allyl, tertiary alkyl, such as tertiary butyl, methyl and silyl groups.

The compounds of formula (III) and (IV) are described in commonly owned copending U.S. applications Ser. No. 09/665,528, filed Sep. 19, 2000, and Ser. No. 09/799,798, filed Mar. 6, 2001, the entire disclosure of each of which is hereby incorporated by reference.

As used herein, the term “alkyl” refers to straight chain and branched C1-C25 alkyl. The term “substituted alkyl” refers to C1-C25 alkyl substituted with one or more lower C1-C10 alkyl, lower alkoxy, lower alkylthio, or lower dialkylamino. The term “cycloalkyl” refers to one or more rings, typically of 5, 6 or 7 atoms, which rings may be fused or unfused, and generally including 3 to 12 carbon atoms. The term “substituted cycloalkyl” refers to cycloalkyl as defined above and substituted with one or more lower C1-C10 alkyl, lower alkoxy, lower alkylthio, or lower dialkylamino. The term “aryl” refers to C5-C25 aryl having one or more aromatic rings, generally each of 5 or 6 carbon atoms. Multiple aryl rings may be fused, as in naphthyl or unfused, as in biphenyl. The term “substituted aryl” refers to C5-C25 aryl substituted with one or more lower C1-C10 alkyl, lower alkoxy, lower alkylthio, or lower dialkylamino. Exemplary aryl and substituted aryl groups include, for example, phenyl, benzyl, and the like. The term “alkoxy” refers to straight chain and branched C1-C25 alkoxy. The term “substituted alkoxy” refers to C1-C25 alkoxy substituted with one or more lower C1-C10 alkyl, lower alkoxy, lower alkylthio, or lower dialkylamino. The terms “heteroaryl” and “substituted heteroaryl” refer to aryl and substituted aryl as defined above which can include one to four heteroatoms, like oxygen, sulfur, or nitrogen or a combination thereof, which heteroaryl group is optionally substituted at carbon and/or nitrogen atom(s) with the groups such as noted above. The terms “heterocycloalkyl” and “substituted heterocycloalkyl” refer to cycloalkyl and substituted cycloalkyl as defined above having one or more rings of 5, 6 or 7 atoms with or without saturation or aromatic character and at least one ring atom which is not carbon. Exemplary heteroatoms include sulfur, oxygen, and nitrogen. Multiple rings may be fused or unfused. The term silyl refers to an organosilicon compound, typically having from 3 to 25 carbon atoms. Advantageous silyl protecting groups include linear and branched alkyl substituents, such as exemplified by the silyl groups tertiary butyl, dimethyl silyl and trimethyl silyl.

The increased thermal stability of these formulations can be manifested in higher carbon bound lithium values, as measured by titration, versus the identical formulation without the additive. In addition, minimal amounts of hazardous by-products are typically produced in these formulations, due to the increased thermal stability. For example, these stabilized formulations can be clear solutions (very low turbidity), free of suspended lithium hydride. The corresponding untreated formulations are typically opaque, with significant quantities of lithium hydride suspended. The turbidity of the untreated solutions can be significantly higher than the stabilized formulations, as determined on a nephelometer.

As used herein the term “thermal stability” of the compositions of the invention refers to compositions having higher carbon bound lithium values (or increased active carbon-lithium species) as compared to formulations without an additive. Preferably the compositions of the invention have carbon bound lithium values of at least about 90% and higher, determined using titration, after the compositions are stored for 5 days at 40° C. Alternatively “thermal stability” refers to compositions having decreased lithium hydride precipitation.

It is believed that these additives interact with the functionalized alkyllithium compounds, as can be determined by proton and/or carbon nuclear magnetic resonance (NMR). Although not wishing to be bound by any explanation of the invention, it is currently believed that these interactions stabilize the functionalized alkyllithium species to prevent or minimize thermal degradation. However, the interactions are reversible, and thus still allow the functionalized alkyllithium species to perform the desired chemistry, such as deprotonate an organic acid, or initiate an anionic polymerization. Thus, the additives can be generally be described as compounds which are capable of reversibly interacting with the alkyllithium species in a hydrocarbon solvent system to stabilize the alkyllithium species and to allow the alkyllithium species to perform the desired chemistry in downstream applications.

The compositions of this invention may be prepared in several ways. The preferred technique depends on various factors such as but not limited to the identity of the functionalized alkyllithium species and the identity of the additive(s). Generally one or more organometallic compounds and/or precursor(s) thereof can be added to the composition prior to, during or after the synthesis of the functionalized alkyllithium species. For example, an organometallic additive and/or its precursor may be added during the synthesis of the functionalized alkyllithium species. In this mode, the organometallic compound and/or its precursor can be added to solvent prior to or substantially simultaneously with the addition of an alkyllithium precursor halide. The organometallic compound and/or its precursor may also be mixed with the alkyllithium precursor halide, and thus added substantially simultaneously to the reactor with the alkyllithium precursor halide. The organometallic compound and/or its precursor can aternatively be added to the reaction mixture after addition of an alkyllithium precursor halide. Still further, the organometallic compound and/or its precursor can be introduced into a lithium dispersion and thus added to a reaction mixture substantially simultaneously with the addition of the lithium dispersion. In another mode, the organometallic compound and/or its precursor may be added to the formulation after the synthesis of the alkyllithium is substantially complete, either prior to or after filtration to remove the by-product lithium halide.

As a non-limiting example, in one embodiment, an organometallic compound precursor, such as a metal precursor like magnesium metal, can be added to solvent in a reactor prior to or substantially simultaneously with the addition of the alkyllithium precursor halide. As another non-limiting example, an active metal halide or alkoxide can be added to the alkyllithium composition, again prior to, during or after the synthesis reaction. Typically the active metal halide or alkoxide precursor is added to the composition after the synthesis reaction, either prior to or after filtration. The active metal halide or alkoxide can be represented generally by the formula MeXₙ, wherein Me is the metal, X is halide or C1-C10 alkoxide, and n is the valence of the metal.

Unexpectedly, it was discovered that the yield of the alkyllithium species and the carbon bound lithium value of the resultant alkyllithium can be higher when certain additives are present during the synthesis. This can be demonstrated by increased carbon-bound lithium values and/or yields with the addition of the additives to the compositions.

The organometallic compound is present in an amount sufficient to thermally stabilize the alkyllithium species without significantly compromising or inhibiting the reactivity of the alkyllithium species. The quantity of the additive required depends on several factors, including without limitation the identity of the functionalized alkyllithium species, the concentration of the alkyllithium species, the solvent, the identity of the additive(s), and the storage temperature. In general, the organometallic additives are employed in an amount less than about 10 mol %, based on the amount of alkyllithium species present (or less than about 0.1 molar equivalents). As little as about 0.1 mol % (or 0.001 mol equivalents) additive, based on the amount of alkyllithium species, may be employed. Even amounts of the additive as low as 0.001 mol % (or 0.00001 mol equivalents) can be effective to thermally stabilize the compositions of the invention. Advantageously the additive is present in an amount ranging from about 1 to about 7 mol % (about 0.01 to about 0.07 equivalents), based on the amount of alkyllithium species present.

The inert solvent employed in the formulation is preferably a non-polar solvent such as a hydrocarbon. Inert hydrocarbon solvents useful in practicing this invention include but are not limited to inert liquid alkanes, cycloalkanes and aromatic solvents such as alkanes and cycloalkanes containing five to ten carbon atoms such as pentane, hexane, cyclohexane, methylcyclohexane, heptane, methylcycloheptane, octane, decane and so forth and aromatic solvents containing six to ten carbon atoms such as benzene, toluene, ethylbenzene, p-xylene, m-xylene, o-xylene, n-propylbenzene, isopropylbenzene, n-butylbenzene, and the like, as well as mixtures of such solvents.

The present invention will be further illustrated by the following non-limiting examples.

### EXAMPLE 1

### Preparation of 3-Trimethylsilyloxy-1-propyllithium with Dibutylmagnesium

A 500 mL, three-necked Morton flask was equipped with a mechanical stirrer, a Claisen adapter fitted with a dry ice condenser and gas inlet, and a 100 milliliter pressure-equalizing dropping funnel. This apparatus was dried in an oven overnight at 125° C., assembled hot, and allowed to cool to room temperature. Lithium metal dispersion was washed free of mineral oil with hexane (2×100 ml), and pentane (1×100 ml). The resultant lithium dispersion was dried in a stream of argon, weighed, 6.05 grams (0.87 moles) and transferred to the reaction flask with cyclohexane (181 g). To the lithium suspension was added 15 wt % dibutylmagnesium (14 g, 0.015 mol) in heptane. The mechanical stirrer was set at an agitation rate of 500 RPMs, and the reaction mixture was heated to 65° C. with a heating mantle. The heat source was removed. The dropping funnel was charged with 3-trimethylsilyloxy-1-propylchloride (52.2 g, 0.31 mol). The precursor was added dropwise, at an approximate feed rate of 1.63 ml/min. The reaction mixture was maintained at 60° C. with a dry ice/hexane bath. The reaction was allowed to stir for an additional one hour and maintained at a temperature of 60° C. with a heating mantle. The reaction mixture was then allowed to cool to room temperature and transferred to a medium porosity pressure filter. The lithium muds were washed with cyclohexane (1×43 gms) to afford 260.1 gms (75.5% yield based on % active) of the title compound in cyclohexane.

### Comparative Example

### Preparation of 3-Trimethylsilyloxy-1-propyllithium without Dibutylmagnesium

A 500 mL, three-necked Morton flask was equipped with a mechanical stirrer, a Claisen adapter fitted with a dry ice condenser and gas inlet, and a 100 milliliter pressure-equalizing dropping funnel. This apparatus was dried in an oven overnight at 125° C., assembled hot, and allowed to cool to room temperature in a stream of argon. Lithium metal dispersion was washed free of mineral oil with hexane (2×100 ml), and pentane (1×100 ml). The resultant lithium dispersion was dried in a stream of argon, weighed, 9.9 grams (1.43 moles) and transferred to the reaction flask with cyclohexane (310 g). The mechanical stirrer was set at an agitation rate of 500 RPMs, and the reaction mixture was heated to 65° C. with a heating mantle. The heat source was removed. The dropping funnel was charged with 3-trimethylsilyloxy-1-propylchloride (85.01 g, 0.51 mol). The precursor was added dropwise, at an approximate feed rate of 1.63 ml/min. The reaction mixture was maintained at 60° C. with a dry ice/hexane bath. The reaction was allowed to stir for an additional one hour and maintained at a temperature of 60° C. with a heating mantle. The reaction mixture was then allowed to cool to room temperature and transferred to a medium porosity pressure filter. The lithium muds were washed with cyclohexane (1×50 gms) to afford 381.7 gms (52.6% yield based on % active) of the title compound in cyclohexane.

The stability of 3-trimethylsilyloxy-1-propyllithum (TMSO-(CH₂)₃—Li) in the presence of dibutylmagnesium (DBM) as prepared in Example 1 was evaluated and compared with the stability of TMSO-(CH₂)₃—Li without DBM as prepared in the above comparative example. The results are set forth in the table below. Thermal stability was evaluated by analyzing samples of the solutions for total base and for active, carbon-bound lithium, by the method of S. C. Watson and J. F. Eastham, J. Organomet. Chem., 9, 165 (1967). The data demonstrates that the presence of the additive improves stability as exemplified by increased yield and an increase in the carbon bound lithium value.

| | | | | CARBON | |
|---|---|---|---|---|---|
| | | | ACTIVE WT | BOUND | |
| Alkyllithium | ADDITIVE | LOADING | % | LITHIUM | YIELD |
| TMSO-(CH₂)₃-Li | None | 0 | 9.7 | 62.2 | 52.6 |
| TMSO-(CH₂)₃-Li | Dibutylmagnesuim | 5 mol % | 12.57 | 81.3 | 75.5 |

### EXAMPLE 2

### Preparation of 2,2-Dimethyl-3-trimethylsilyloxy-1-propyllithium and Stability Comparison of Same with and without Dibutylmagnesium

A 1 L Morton flask was equipped with a mechanical stirrer, a Claisen adapter fitted with a dry ice condenser and gas inlet, and a 100 milliliter pressure-equalizing dropping funnel. This apparatus was dried in an oven overnight at 125° C., assembled hot, and allowed to cool to room temperature in a stream of argon. Lithium metal dispersion was washed free of mineral oil with hexane (2×100 ml), and pentane (1×100 ml). The resultant lithium dispersion was dried in a stream of argon, weighed, 8.47 grams (1.2 moles) and transferred to the reaction flask with cyclohexane (320 g). The mechanical stirrer was set at an agitation rate of 500 RPMs, and the reaction mixture was heated to 70° C. with a heating mantle. The heat source was removed. The dropping funnel was charged with 2,2-dimethyl-3-trimethylsilyloxy-1-propylchloride (84.82 g, 0.44 mol). The precursor was added dropwise, at an approximate feed rate of 1.63 ml/min. The reaction mixture was maintained at 65° C. with a dry ice/hexane bath. The reaction was allowed to stir for an additional one hour and maintained at a temperature of 65° C. with a heating mantle. The reaction mixture was then allowed to cool to room temperature and transferred to a medium porosity pressure filter. The lithium muds were washed with cyclohexane (1×49 gms) to afford 452 gms (90.0% yield based on % active) of the title compound in cyclohexane.

The stability of 2,2-dimethyl-3-trimethylsilyloxy-1-propyllithium was performed in a separate experiment. The prepared 2,2-dimethyl-3-trimethylsilyloxy-1-propyllithium was separated into three different lots. Lot 1 contained 14.4 wt % 2,2-dimethyl-3-trimethylsilyloxy-1-propyllithium (87.09 g). Lot 2 contained 14.4 wt % 2,2-dimethyl-3-trimethylsilyloxy-1-propyllithium (87.09 g) and was treated with 14.0 wt % dibutylmagnesium (0.77 g). Lot 3 contained 14.4 wt % 2,2-dimethyl-3-trimethylsilyloxy-1-propyllithium (88.25 g) and was treated with 14.0 wt % dibutylmagnesium (3.74 g). The table below shows the difference in activity after the samples were aged 13 and 36 days at 15° C.

| | | Lot 2 | Lot 3 |
|---|---|---|---|
| | | (1.2 mol % | (5.8 mol % |
| | Lot 1 (control) | DBM) | DBM) |
| 13 days @ 15° C. | | | |
| Total base (mol/kg) | 0.92 | 0.91 | 0.96 |
| Active (mol/kg) | 0.86 | 0.90 | 0.92 |
| 36 days @ 15° C. | | | |
| Total base (mol/kg) | 0.87 | 0.91 | 0.95 |
| Active (mol/kg) | 0.43 | 0.88 | 0.90 |

The following table demonstrates a two fold increase in storage stability for TMSOCH₂C(CH₃)₂CH₂Li when treated with dibutylmagnesium after the 3-(trimethylsilyloxy)-2,2-dimethyl-1-propyllithium was prepared and isolated.

| | | | | | CARBON |
|---|---|---|---|---|---|
| | | | Days @ | ACTIVE WT | BOUND |
| Alkyllithium | ADDITIVE | LOADING | 15° C. | % | LITHIUM |
| TMSOCH₂C(CH₃)₂CH₂-Li | None | 0 | 36 days | 7.1 | 49% |
| TMSOCH₂C(CH₃)₂CH₂-Li | Dibutylmagnesium | 1 mol % | 36 days | 14.5 | 97% |
| TMSOCH₂C(CH₃)₂CH₂-Li | Dibutylmagnesium | 5 mol % | 36 days | 14.9 | 95% |

The foregoing examples are illustrative of the present invention and are not to be construed as limiting thereof. Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A functionalized alkyllithium composition having enhanced thermal stability, comprising:
at least one functionalized alkyllithium compound; and
at least one organometallic compound capable of forming an ate complex with said alkyllithium compound in an amount sufficient to impart thermal stability to the composition without significantly inhibiting the reactivity of the alkyllithium species.

2. The composition of claim 1, wherein said composition has a carbon bound lithium value of at least about 90%, determined using titration, after being stored for 5 days at 40° C.

3. The composition of claim 1, wherein said organometallic compound is soluble in hydrocarbon solvents.

4. The composition of claim 1, wherein said organometallic compound has the formula MetR′ₙ, wherein:
Met is a metal selected from Group IIA, Group IIB, and Group IIIB of the Periodic Table of Elements;
each R′ is independently selected from linear or branched C1-C20 aliphatic hydrocarbons, C2-C20 cycloaliphatic hydrocarbons, C5-C20 aromatic hydrocarbons, and mixtures thereof; and
n is the valence of Met.

5. The composition of claim 4, wherein said organometallic compound has the formula M¹R²⁰R²¹, wherein:
M¹ is an element of Group IIA or Group IIB; and
each R²⁰ and R²¹ is selected from the group consisting of linear or branched C1-C20 aliphatic hydrocarbons, C2-C20 cycloaliphatic hydrocarbons, C5-C20 aromatic hydrocarbons, and mixtures thereof.

6. The composition of claim 5, wherein M¹ is selected from the group consisting of beryllium, magnesium, calcium, strontium, barium, radium, zinc, cadmium, and mercury.

7. The composition of claim 5, wherein M¹ is magnesium.

8. The composition of claim 5, wherein M¹ is zinc.

9. The composition of claim 4, wherein said organometallic compound has the formula M²R²³R²⁴R²⁵, wherein:
M² is an element of Group IIIB; and
each R²³, R²⁴, and R²⁵ is selected from the group consisting of linear or branched C1-C20 aliphatic hydrocarbons, C2-C20 cycloaliphatic hydrocarbons, C5-C20 aromatic hydrocarbons, and mixtures thereof.

10. The composition of claim 9, wherein M² is selected from the group consisting of boron, aluminum, gallium, indium, and thallium.

11. The composition of claim 9, wherein M² is aluminum.

12. The composition of claim 1, wherein said organometallic compound is selected from the group consisting of diethylmagnesium, diisopropylmagnesium, dibutylmagnesium, dicyclohexylmagnesium, diphenylmagnesium, diethylzinc, dibutylzinc, diphenyl zinc, triethylaluminum, tripropylaluminum, triisopropylaluminum, tributylaluminum, trioctylaluminum, trimethylboron, triethylboron, and tributylboron and mixtures thereof.

13. The composition of claim 1, wherein said at least one functionalized alkyllithium compound comprises one or more compounds of the formula
Li—Qₙ—Z—T—(A—R₁₀R₁₁R₁₂)ₘ
or 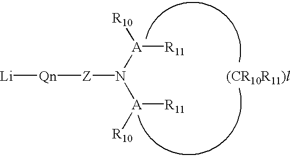
wherein:
Q is a saturated or unsaturated hydrocarbyl group derived by incorporation of one or more conjugated diene hydrocarbons, one or more alkenylaromatic compounds, or mixtures of one or more dienes with one or more alkenylaromatic compounds into the M—Z linkage;
n is from 0 to 5;
Z is a branched or straight chain hydrocarbon connecting group which contains 3-25 carbon atoms, optionally substituted with C5-C25 aryl;
T is selected from the group consisting of oxygen, sulfur, and nitrogen groups and mixtures thereof;
(A—R₁₀R₁₁R₁₂)ₘ is a protecting group in which A is an element selected from Group IVa of the Periodic Table of the Elements, and R₁₀, R₁₁, and R₁₂ are each independently selected from the group consisting of hydrogen, C1-C15 alkyl, substituted C1-C15 alkyl, C5-C25 aryl, substituted C5-C25 aryl, C5-C12 cycloalkyl and substituted C5-C12 cycloalkyl;
l is an integer from 1 to 7; and
m is 1 when T is oxygen or sulfur, and 2 when T is nitrogen.

14. The composition of claim 13, wherein said functionalized alkyllithium compound is selected from the group consisting of 3-(t-butyldimethylsilyloxy)-1-propyllithium, 3-(t-butyldimethyl-silyloxy)-2-methyl-1-propyllithium, 3-(t-butyldimethylsilyloxy)-2,2-dimethyl-1-propyllithium, 4-(t-butyldimethylsilyloxy)-1-butyllithium, 5-(t-butyldimethyl-silyloxy)-1-pentyllithium, 6-(t-butyldimethylsilyloxy)-1-hexyllithium, 8-(t-butyldimethylsilyloxy)-1-octyllithium, 3-(t-butyldiphenylsilyloxy)-1-propyllithium, 3-(t-butyldiphenylylsiloxy)-2-methyl-1-propyllithium, 3-(t-butyldiphenylsilyloxy)-2,2-dimethyl-1-propyllithium, 6-(t-butyldiphenylsilyloxy)-1-hexyllithium, 3-(triisopropylsilyloxy)-1-propyllithium, 3-(trimethylsilyloxy)-2,2-dimethyl-1-propyllithium, 3-(triethylsilyloxy)-2,2-dimethyl-1-propyllithium, 3-(1,1-dimethylethoxy)-1-propyllithium, 3-(1,1-dimethylethoxy)-2-methyl-1-propyllithium, 3-(1,1-dimethylethoxy)-2,2-dimethyl-1-propyllithium, 4-(1,1-dimethylethoxy)-1-butyllithium, 5-(1,1-dimethylethoxy)-1-pentyllithium, 6-(1,1-dimethylethoxy)-1-hexyllithium, 8-(1,1-dimethylethoxy)-1-octyllithium, 3-(1,1-dimethylpropoxy)-1-propyllithium, 3-(1,1-dimethylpropoxy)-2-methyl-1-propyllithium, 3-(1,1-dimethylpropoxy)-2,2-dimethyl-1-propyllithium, 4-(1,1-dimethylpropoxy)-1-butyllithium, 5-(1,1-dimethylpropoxy)-1-pentyllithium, 6-(1,1-dimethylpropoxy)-1-hexyllithium, 8-(1,1-dimethylpropoxy)-1-octyllithium, 4-(methoxy)-1-butyllithium, 4-(ethoxy)-1-butyllithium, 4-(n-propyloxy)-1-butyllithium, 4-(1-methylethoxy)-1-butyllithium, 3-[3-(dimethylamino)-1-propyloxy]-1-propyllithium, 3-[2-(dimethylamino)-1-ethoxy]-1-propyllithium, 3-[2-(diethylamino)-1-ethoxy]-1-propyllithium, 3-[2-(diisopropyl)amino)-1-ethoxy]-1-propyllithium, 3-[2-(1-piperidino)-1-ethoxy]-1-propyllithium, 3-[2-(1-pyrrolidino)-1-ethoxy]-1-propyllithium, 4-[3-(dimethylamino)-1-propyloxy]-1-butyllithium, 6-[2-(1-piperidino)-1-ethoxy]-1-hexyllithium, 3-[2-(methoxy)-1-ethoxy]-1-propyllithium, 3-[2-(ethoxy)-1-ethoxy]-1-propyllithium, 4-[2-(methoxy)-1-ethoxy]-1-butyllithium, 5-[2-(ethoxy)-1-ethoxy]-1-pentyllithium, 3-[3-(methylthio)-1-propyloxy]-1-propyllithium, 3-[4-(methylthio)-1-butyloxy]-1-propyllithium, 3-(methylthiomethoxy)-1-propyllithium, 6-[3-(methylthio)-1-propyloxy]-1-hexyllithium, 3-(N,N-dimethylamino)-1-propyllithium, 3-(N,N-dimethylamino)-2-methyl-1-propyllithium, 3-(N,N-dimethylamino)-2,2-dimethyl-1-propyllithium, 4-(N,N-dimethylamino)-1-butyllithium, 5-(N,N-dimethylamino)-1-pentyllithium, 6-(N,N-dimethylamino)-1-hexyllithium, 3-(N,N-diethylamino)-1-propyllithium, 3-(N,N-diethylamino)-2-methyl-1-propyllithium, 3-(N,N-diethylamino)-2,2-dimethyl-1-propyllithium, 4-(N,N-diethylamino)-1-butyllithium, 5-(N,N-diethylamino)-1-pentyllithium, 6-(N,N-diethylamino)-1-hexyllithium, 3-(N-ethyl-N-methylamino)-1-propyllithium, 3-(N-ethyl-N-methylamino)-2-methyl-1-propyl halide, 3-(N-ethyl-N-methylamino)-2,2-dimethyl-1-propyl halide, 4-(N-ethyl-N-methylamino)-1-butyllithium, 5-(N-ethyl-N-methylamino)-1-pentyllithium, 6-(N-ethyl-N-methylamino)-1-hexyllithium, 3-(piperidino)-1-propyllithium, 3-(piperidino)-2-methyl-1-propyllithium, 3-(piperidino)-2,2-dimethyl-1-propyllithium, 4-(piperidino)-1-butyllithium, 5-(piperidino)-1-pentyllithium, 6-(piperidino)-1-hexyllithium, 3-(pyrrolidino)-1-propyllithium, 3-(pyrrolidino)-2-methyl-1-propyllithium, 3-(pyrrolidino)-2,2-dimethyl-1-propyllithium, 4-(pyrrolidino)-1-butyllithium, 5-(pyrrolidino)-1-pentyllithium, 6-(pyrrolidino)-1-hexyllithium, 3-(hexamethyleneimino)-1-propyllithium, 3-(hexamethyleneimino)-2-methyl-1-propyllithium, 3-(hexamethyleneimino)-2,2-dimethyl-1-propyllithium, 4-(hexamethyleneimino)-1-butyllithium, 5-(hexamethyleneimino)-1-pentyllithium, 6-(hexamethyleneimino)-1-hexyllithium, 3-(2,2,5,5-tetramethyl-2,5-disila-1-azacyclopentane)-1-propyllithium, 4-(2,2,5,5-tetramethyl-2,5-disila-1-azacyclopentane)-1-butyllithium, 6-(2,2,5,5-tetramethyl-2,5-disila-1-azacyclopentane)-1-hexyllithium, 3-(N-isopropyl-N-methyl)-1-propyllithium, 2-(N-isopropyl-N-methyl)-2-methyl-1-propyllithium, 3-(N-isopropyl-N-methyl)-2,2-dimethyl-1-propyllithium, and 4-(N-isopropyl-N-methyl)-1-butyllithium, 3-(methylthio)-1-propyllithium, 3-(methylthio)-2-methyl-1-propyllithium, 3-(methylthio)-2,2-dimethyl-1-propyllithium, 4-(methylthio)-1-butyllithium, 5-(methylthio)-1-pentyllithium, 6-(methylthio)-1-hexyllithium, 8-(methylthio)-1-octyllithium, 3-(methoxymethylthio)-1-propyllithium, 3-(methoxymethylthio)-2-methyl-1-propyllithium, 3-(methoxymethylthio)-2,2-dimethyl-1-propyllithium, 4-(methoxymethylthio)-1-butyllithium, 5-(methoxymethylthio)-1-pentyllithium, 6-(methoxymethylthio)-1-hexyllithium, 8-(methoxymethylthio)-1-octyllithium, 3-(1,1-dimethylethylthio)-1-propyllithium, 3-(1,1-dimethylethylthio)-2-methyl-1-propyllithium, 3-(1,1-dimethylethylthio)-2,2-dimethyl-1-propyllithium, 4-(1,1-dimethylethylthio)-1-butyllithium, 5-( 1,1-dimethylethylthio)-1-pentyllithium, 6-( 1,1-dimethylethylthio)-1-hexyllithium, 8-(1,1-dimethylethylthio)-1-octyllithium, 3-(1,1-dimethylpropylthio)-1-propyllithium, 3-(1,1-dimethylpropylthio)-2-methyl-1-propyllithium, 3-(1,1-dimethylpropylthio)-2,2-dimethyl-1-propyllithium, 4-(1,1-dimethylpropylthio)-1-butyllithium, 5-(1,1-dimethylpropylthio)-1-pentyllithium, 6-(1,1-dimethylpropylthio)-1-hexyllithium, 8-(1,1-dimethylpropylthio)-1-octyllithium, 3-(cyclopentylthio)-1-propyllithium, 3-(cyclopentylthio)-2-methyl-1-propyllithium, 3-(cyclopentylthio)-2,2-dimethyl-1-propyllithium, 4-(cyclopentylthio)-1-butyllithium, 5-(cyclopentylthio)-1-pentyllithium, 6-(cyclopentylthio)-1-hexyllithium, 8-(cyclopentylthio)-1-octyllithium, 3-(cyclohexylthio)-1-propyllithium, 3-(cyclohexylthio)-2-methyl-1-propyllithium, 3-(cyclohexylthio)-2,2-dimethyl-1-propyllithium, 4-(cyclohexylthio)-1-butyllithium, 5-(cyclohexylthio)-1-pentyllithium, 6-(cyclohexylthio)-1-hexyllithium, 8-(cyclohexylthio)-1-octyllithium, 3-(t-butyldimethylsilylthio)-1-propyllithium, 3-(t-butyldimethylsilylthio)-2-methyl-1-propyllithium, 3-(t-butyldimethylsilylthio)-2,2-dimethyl-1-propyllithium, 3-(t-butyldimethylsilylthio)-2-methyl-1-propyllithium, 4-(t-butyldimethylsilylthio)-1-butyllithium, 6-(t-butyldimethylsilylthio)-1-hexyllithium and 3-(trimethylsilylthio)-2,2-dimethyl-1-propyllithium, chain extended analogs thereof and mixtures thereof.

15. The composition of claim 1, wherein said organometallic compound is present in an amount less than about 10 mol %, based on the amount of alkyllithium species present.

16. The composition of claim 1, wherein said organometallic compound is present in an amount ranging from about 0.001 mol % to less than about 10 mol %, based on the amount of alkyllithium species present.

17. The composition of claim 1, wherein said organometallic compound is present in an amount ranging from about 1 to about 7 mol %, based on the amount of alkyllithium species present.

18. The composition of claim 1, wherein said composition comprises a hydrocarbon solvent selected from the group consisting of alkanes, cycloalkanes and aromatic solvents and mixtures thereof.

19. A functionalized alkyllithium composition having enhanced thermal stability, comprising:
at least one functionalized alkyllithium compound; and
at least one organometallic compound capable of forming an ate complex with said functionalized alkyllithium compound in an amount of less than about 10 mol %, based on the amount of alkyllithium species present, to impart thermal stability to the composition without significantly inhibiting the reactivity of the alkyllithium species, said at least one functionalized alkyllithium compound comprising one or more compounds of the formula
Li—Qₙ—Z—T—(A—R₁₀R₁₁R₁₂)ₘ
or 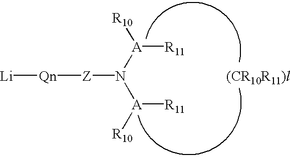
wherein:
Q is a saturated or unsaturated hydrocarbyl group derived by incorporation of one or more conjugated diene hydrocarbons, one or more alkenylaromatic compounds, or mixtures of one or more dienes with one or more alkenylaromatic compounds into the M—Z linkage;
n is from 0 to 5;
Z is a branched or straight chain hydrocarbon connecting group which contains 3-25 carbon atoms, optionally substituted with C5-C25 aryl;
T is selected from the group consisting of oxygen, sulfur, and nitrogen groups and mixtures thereof;
(A—R₁₀R₁₁R₁₂)ₘ is a protecting group in which A is an element selected from Group IVa of the Periodic Table of the Elements, and R₁₀, R₁₁, and R₁₂ are each independently selected from the group consisting of hydrogen, C1-C15 alkyl, substituted C1-C15 alkyl, C5-C25 aryl, substituted C5-C25 aryl, C5-C12 cycloalkyl and substituted C5-C12 cycloalkyl;
l is an integer from 1 to 7; and
m is 1 when T is oxygen or sulfur, and 2 when T is nitrogen.

20. The composition of claim 19, wherein A is carbon.

21. The composition of claim 20, wherein T is nitrogen.

22. The composition of claim 20, wherein T is oxygen.

23. The composition of claim 20, wherein said organometallic compound is dibutylmagnesium.

24. The composition of claim 19, wherein A is silicon.

25. The composition of claim 24, wherein said functionalized alkyllithium is 3-trimethylsilyloxy-1-propyllithium.

26. The composition of claim 24, wherein said functionalized alkyllithium is 2,2-dimethyl-3-trimethylsilyloxy-1-propyllithium.

27. A process for preparing functionalized alkyllithium compositions having enhanced thermal stability, comprising:
reacting a functionalized alkylhalide with lithium to form a functionalized alkyllithium composition; and
adding at least one organometallic compound or precursor thereof capable of forming an ate complex with a functionalized alkyllithium to said composition in an amount sufficient to impart thermal stability to the composition without significantly inhibiting the reactivity of the alkyllithium species prior to, during or after the synthesis of said functionalized alkyllithium.

28. The process of claim 27, wherein said composition has a carbon bound lithium value of at least about 90%, determined using titration, after being stored for 5 days at 40° C.

29. The process of claim 27, wherein said organometallic compound is soluble in hydrocarbon solvents.

30. The process of claim 27, wherein said organometallic compound is a compound of the formula MetR′ₙ, wherein:
Met is a metal selected from Group IIA, Group IIB, and Group IIIB of the Periodic Table of Elements;
each R′ is independently selected from linear or branched C1-C20 aliphatic hydrocarbons, C2-C20 cycloaliphatic hydrocarbons, C5-C20 aromatic hydrocarbons, and mixtures thereof; and
n is the valence of Met.

31. The process of claim 30, wherein said organometallic compound has the formula M¹R²⁰R²¹, wherein:
M¹ is an element of Group IIA or Group IIB; and
each R²⁰ and R²¹ is selected from the group consisting of linear or branched C1-C20 aliphatic hydrocarbons, C2-C20 cycloaliphatic hydrocarbons, C5-C20 aromatic hydrocarbons, and mixtures thereof.

32. The process of claim 31, wherein M is selected from the group consisting of beryllium, magnesium, calcium, strontium, barium, radium, zinc, cadmium, and mercury.

33. The process of claim 31, wherein M¹ magnesium.

34. The process of claim 31, wherein M¹ is zinc.

35. The process of claim 30, wherein said organometallic compound is a compound of the formula M²R²³R²⁴R²⁵, wherein:
M² is an element of Group IIIB; and
each R²³, R²⁴, and R²⁵ is selected from the group consisting of linear or branched C1-C20 aliphatic hydrocarbons, C2-C20 cycloaliphatic hydrocarbons, C5-C20 aromatic hydrocarbons, and mixtures thereof.

36. The process of claim 35, wherein M² is selected from the group consisting of boron, aluminum, gallium, indium, and thallium.

37. The process of claim 35, wherein M² is aluminum.

38. The process of claim 27, wherein said organometallic compound is selected from the group consisting of diethylmagnesium, diisopropylmagnesium, dibutylmagnesium, dicyclohexylmagnesium, diphenylmagnesium, diethylzinc, dibutylzinc, diphenyl zinc, triethylaluminum, tripropylaluminum, triisopropylaluminum, tributylaluminum, trioctylaluminum, trimethylboron, triethylboron, and tributylboron and mixtures thereof.

39. The process of claim 27, wherein said functionalized alkyllithium compound comprises one or more compounds of the formula
Li—Qₙ—Z—T—(A—R₁₀R₁₁R₁₂)ₘ
or 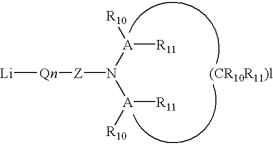
wherein:
Q is a saturated or unsaturated hydrocarbyl group derived by incorporation of one or more conjugated diene hydrocarbons, one or more alkenylaromatic compounds, or mixtures of one or more dienes with one or more alkenyl aromatic compounds into the M—Z linkage;
n is from 0 to 5;
Z is a branched or straight chain hydrocarbon connecting group which contains 3-25 carbon atoms, optionally substituted with C5-C25 aryl;
T is selected from the group consisting of oxygen, sulfur, and nitrogen groups and mixtures thereof;
(A—R₁₀R₁₁R¹²)ₘ is a protecting group in which A is an element selected from Group IVa of the Periodic Table of the Elements, and R₁₀, R₁₁, and R₁₂ are each independently selected from the group consisting of hydrogen, C1-C15 alkyl, substituted C1-C15 alkyl, C5-C25 aryl, substituted C5-C25 aryl, C5-C12 cycloalkyl and substituted C5-C12 cycloalkyl;
l is an integer from 1 to 7; and
m is 1 when T is oxygen or sulfur, and 2 when T is nitrogen.

40. The process of claim 39, wherein said functionalized alkyllithium compound is selected from the group consisting of 3-(t-butyldimethylsilyloxy)-1-propyllithium, 3-(t-butyldimethyl-silyloxy)-2-methyl-1-propyllithium, 3-(t-butyldimethylsilyloxy)-2,2-dimethyl-1-propyllithium, 4-(t-butyldimethylsilyloxy)-1-butyllithium, 5-(t-butyldimethyl-silyloxy)-1-pentyllithium, 6-(t-butyldimethylsilyloxy)-1-hexyllithium, 8-(t-butyldimethylsilyloxy)-1-octyllithium, 3-(t-butyldiphenylsilyloxy)-1-propyllithium, 3-(t-butyldiphenylylsiloxy)-2-methyl-1-propyllithium, 3-(t-butyldiphenylsilyloxy)-2,2-dimethyl-1-propyllithium, 6-(t-butyldiphenylsilyloxy)-1-hexyllithium, 3-(triisopropylsilyloxy)-1-propyllithium, 3-(trimethylsilyloxy)-2,2-dimethyl-1-propyllithium, 3-(triethylsilyloxy)-2,2-dimethyl-1-propyllithium, 3-(1,1-dimethylethoxy)-1-propyllithium, 3-(1,1-dimethylethoxy)-2-methyl-1-propyllithium, 3-(1,1-dimethylethoxy)-2,2-dimethyl-1-propyllithium, 4-(1,1-dimethylethoxy)-1-butyllithium, 5-(1,1-dimethylethoxy)-1-pentyllithium, 6-(1,1-dimethylethoxy)-1-hexyllithium, 8-(1,1-dimethylethoxy)-1-octyllithium, 3-(1,1-dimethylpropoxy)-1-propyllithium, 3-(1,1-dimethylpropoxy)-2-methyl-1-propyllithium, 3-(1,1-dimethylpropoxy)-2,2-dimethyl-1-propyllithium, 4-(1,1-dimethylpropoxy)-1-butyllithium, 5-(1,1-dimethylpropoxy)-1-pentyllithium, 6-(1,1-dimethylpropoxy)-1-hexyllithium, 8-(1,1-dimethylpropoxy)-1-octyllithium, 4-(methoxy)-1-butyllithium, 4-(ethoxy)-1-butyllithium, 4-(n-propyloxy)-1-butyllithium, 4-(1-methylethoxy)-1-butyllithium, 3-[3-(dimethylamino)-1-propyloxy]-1-propyllithium, 3-[2-(dimethylamino)-1-ethoxy]-1-propyllithium, 3-[2-(diethylamino)-1-ethoxy]-1-propyllithium, 3-[2-(diisopropyl)amino)-1-ethoxy]-1-propyllithium, 3-[2-(1-piperidino)-1-ethoxy]-1-propyllithium, 3-[2-(1-pyrrolidino)-1-ethoxy]-1-propyllithium, 4-[3-(dimethylamino)-1-propyloxy]-1-butyllithium, 6-[2-(1-piperidino)-1-ethoxy]-1-hexyllithium, 3-[2-(methoxy)-1-ethoxy]-1-propyllithium, 3-[2-(ethoxy)-1-ethoxy]-1-propyllithium, 4-[2-(methoxy)-1-ethoxy]-1-butyllithium, 5-[2-(ethoxy)-1-ethoxy]-1-pentyllithium, 3-[3-(methylthio)-1-propyloxy]-1-propyllithium, 3-[4-(methylthio)-1-butyloxy]-1-propyllithium, 3-(methylthiomethoxy)-1-propyllithium, 6-[3-(methylthio)-1-propyloxy]-1-hexyllithium, 3-(N,N-dimethylamino)-1-propyllithium, 3-(N,N-dimethylamino)-2-methyl-1-propyllithium, 3-(N,N-dimethylamino)-2,2-dimethyl-1-propyllithium, 4-(N,N-dimethylamino)-1-butyllithium, 5-(N,N-dimethylamino)-1-pentyllithium, 6-(N,N-dimethylamino)-1-hexyllithium, 3-(N,N-diethylamino)-1-propyllithium, 3-(N,N-diethylamino)-2-methyl-1-propyllithium, 3-(N,N-diethylamino)-2,2-dimethyl-1-propyllithium, 4-(N,N-diethylamino)-1-butyllithium, 5-(N,N-diethylamino)-1-pentyllithium, 6-(N,N-diethylamino)-1-hexyllithium, 3-(N-ethyl-N-methylamino)-1-propyllithium, 3-(N-ethyl-N-methylamino)-2-methyl-1-propyl halide, 3-(N-ethyl-N-methylamino)-2,2-dimethyl-1-propyl halide, 4-(N-ethyl-N-methylamino)-1-butyllithium, 5-(N-ethyl-N-methylamino)-1-pentyllithium, 6-(N-ethyl-N-methylamino)-1-hexyllithium, 3-(piperidino)-1-propyllithium, 3-(piperidino)-2-methyl-1-propyllithium, 3-(piperidino)-2,2-dimethyl-1-propyllithium, 4-(piperidino)-1-butyllithium, 5-(piperidino)-1-pentyllithium, 6-(piperidino)-1-hexyllithium, 3-(pyrrolidino)-1-propyllithium, 3-(pyrrolidino)-2-methyl-1-propyllithium, 3-(pyrrolidino)-2,2-dimethyl-1-propyllithium, 4-(pyrrolidino)-1-butyllithium, 5-(pyrrolidino)-1-pentyllithium, 6-(pyrrolidino)-1-hexyllithium, 3-(hexamethyleneimino)-1-propyllithium, 3-(hexamethyleneimino)-2-methyl-1-propyllithium, 3-(hexamethyleneimino)-2,2-dimethyl-1-propyllithium, 4-(hexamethyleneimino)-1-butyllithium, 5-(hexamethyleneimino)-1-pentyllithium, 6-(hexamethyleneimino)-1-hexyllithium, 3-(2,2,5,5-tetramethyl-2,5-disila-1-azacyclopentane)-1-propyllithium, 4-(2,2,5,5-tetramethyl-2,5-disila-1-azacyclopentane)-1-butyllithium, 6-(2,2,5,5-tetramethyl-2,5-disila-1-azacyclopentane)-1-hexyllithium, 3-(N-isopropyl-N-methyl)-1-propyllithium, 2-(N-isopropyl-N-methyl)-2-methyl-1-propyllithium, 3-(N-isopropyl-N-methyl)-2,2-dimethyl-1-propyllithium, and 4-(N-isopropyl-N-methyl)-1-butyllithium, 3-(methylthio)-1-propyllithium, 3-(methylthio)-2-methyl-1-propyllithium, 3-(methylthio)-2,2-dimethyl-1-propyllithium, 4-(methylthio)-1-butyllithium, 5-(methylthio)-1-pentyllithium, 6-(methylthio)-1-hexyllithium, 8-(methylthio)-1-octyllithium, 3-(methoxymethylthio)-1-propyllithium, 3-(methoxymethylthio)-2-methyl-1-propyllithium, 3-(methoxymethylthio)-2,2-dimethyl-1-propyllithium, 4-(methoxymethylthio)-1-butyllithium, 5-(methoxymethylthio)-1-pentyllithium, 6-(methoxymethylthio)-1-hexyllithium, 8-(methoxymethylthio)-1-octyllithium, 3-(1,1-dimethylethylthio)-1-propyllithium, 3-(1,1-dimethylethylthio)-2-methyl-1-propyllithium, 3-(1,1-dimethylethylthio)-2,2-dimethyl-1-propyllithium, 4-(1,1-dimethylethylthio)-1-butyllithium, 5-(1,1-dimethylethylthio)-1-pentyllithium, 6-(1,1-dimethylethylthio)-1-hexyllithium, 8-(1,1-dimethylethylthio)-1-octyllithium, 3-(1,1-dimethylpropylthio)-1-propyllithium, 3-(1,1-dimethylpropylthio)-2-methyl-1-propyllithium, 3-(1,1-dimethylpropylthio)-2,2-dimethyl-1-propyllithium, 4-(1,1-dimethylpropylthio)-1-butyllithium, 5-(1 1-dimethylpropylthio)-1-pentyllithium, 6-( 1,1-dimethylpropylthio)-1-hexyllithium, 8-(1,1-dimethylpropylthio)-1-octyllithium, 3-(cyclopentylthio)-1-propyllithium, 3-(cyclopentylthio)-2-methyl-1-propyllithium, 3-(cyclopentylthio)-2,2-dimethyl-1-propyllithium, 4-(cyclopentylthio)-1-butyllithium, 5-(cyclopentylthio)-1-pentyllithium, 6-(cyclopentylthio)-1-hexyllithium, 8-(cyclopentylthio)-1-octyllithium, 3-(cyclohexylthio)-1-propyllithium, 3-(cyclohexylthio)-2-methyl-1-propyllithium, 3-(cyclohexylthio)-2,2-dimethyl-1-propyllithium, 4(cyclohexylthio)-1-butyllithium, 5-(cyclohexylthio)-1-pentyllithium, 6-(cyclohexylthio)-1-hexyllithium, 8-(cyclohexylthio)-1-octyllithium, 3-(t-butyldimethylsilylthio)-1-propyllithium, 3-(t-butyldimethylsilylthio)-2-methyl-1-propyllithium, 3-(t-butyldimethylsilylthio)-2,2-dimethyl-1-propyllithium, 3-(t-butyldimethylsilylthio)-2-methyl-1-propyllithium, 4-(t-butyldimethylsilylthio)-1-butyllithium, 6-(t-butyldimethylsilylthio)-1-hexyllithium and 3-(trimethylsilylthio)-2,2-dimethyl-1-propyllithium, chain extended analogs thereof and mixtures thereof.

41. The process of claim 27, wherein said adding step comprises adding said organometallic compound or precursor thereof in an amount in an amount less than about 10 mol %, based on the amount of alkyllithium species present.

42. The process of claim 27, wherein said adding step comprises adding said organometallic compound or precursor thereof in an amount ranging from about 0.001 mol % to less than about 10 mol %, based on the amount of alkyllithium species present.

43. The process of claim 27, wherein said adding step comprises adding said organometallic compound or precursor thereof in an amount ranging from about 1 to about 7 mol %, based on the amount of alkyllithium species present.

44. The process of claim 27, further comprising adding said functionalized alkylhalide to a reactor prior to said reacting step.

45. The process of claim 44, wherein said adding step comprises adding the organometallic compound or a precursor thereof to the same reactor prior to adding the functionalized alkylhalide to the reactor.

46. The process of claim 44, wherein said adding step comprises adding the organometallic compound or a precursor thereof to the same reactor substantially simultaneously with adding the functionalized alkylhalide to the reactor.

47. The process of claim 46, wherein said adding step comprises mixing said organometallic compound or a precursor thereof with said functionalized alkylhalide to form a functionalized alkylhalide/organometallic compound or precursor mixture and adding said mixture to the reactor.

48. The process of claim 44, wherein said adding step comprises adding the organometallic compound or a precursor thereof to the same reactor after adding the functionalized alkylhalide to the reactor.

49. The process of claim 27, wherein said adding step comprises adding said organometallic compound or a precursor thereof to a lithium dispersion prior to said reacting step.

50. The process of claim 27, wherein said adding step comprises adding said organometallic compound or a precursor thereof to said composition during said reacting step.

51. The process of claim 27, wherein said adding step comprises adding said organometallic compound or a precursor thereof to said composition after said reacting step.

52. The process of claim 27, wherein said adding step comprises adding an organometallic precursor to a reactor prior to said reacting step, and wherein said organometallic precursor comprises a reactive elemental metal.

53. The process of claim 27, wherein said adding step comprises adding an organometallic precursor to said composition after said reacting step, and wherein said organometallic precursor comprises a metal halide or alkoxide.

54. The process of claim 27, further comprising filtering said composition after said reacting step.

55. A process for preparing functionalized alkyllithium compositions having enhanced thermal stability, comprising:
reacting a functionalized alkylhalide with lithium to form a functionalized alkyllithium composition; and
adding at least one organometallic compound or precursor thereof capable of forming an ate complex with a functionalized alkyllithium to said composition prior to, during or after the synthesis of said functionalized alkyllithium, in an amount less than about 10 mol %, based on the amount of alkyllithium species present, to thermally stabilize said alkyllithium without significantly inhibiting the reactivity of the alkyllithium species, wherein said functionalized alkyllithium compound comprises a compound of the formula
Li—Qₙ—Z—T—(A—R₁₀R₁₁R₁₂)ₘ
or 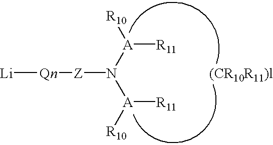
wherein:
Q is a saturated or unsaturated hydrocarbyl group derived by incorporation of one or more conjugated diene hydrocarbons, one or more alkenylaromatic compounds, or mixtures of one or more dienes with one or more alkenylaromatic compounds into the M—Z linkage;
n is from 0 to 5;
Z is a branched or straight chain hydrocarbon connecting group which contains 3-25 carbon atoms, optionally substituted with C5-C25 aryl;
T is selected from the group consisting of oxygen, sulfur, and nitrogen groups and mixtures thereof;
(A—R₁₀R₁₁R¹²)ₘ is a protecting group in which A is an element selected from Group IVa of the Periodic Table of the Elements, and R₁₀, R₁₁, and R₁₂ are each independently selected from the group consisting of hydrogen, C1-C15 alkyl, substituted C1-C15 alkyl, C5-C25 aryl, substituted C5-C25 aryl, C5-C12 cycloalkyl and substituted C5-C12 cycloalkyl;
is an integer from 1 to 7; and
m is 1 when T is oxygen or sulfur, and 2 when T is nitrogen.

56. The process of claim 55, wherein A is carbon.

57. The process of claim 56, wherein said organometallic compound is dibutylmagnesium.

58. The process of claim 55, wherein A is silicon.

59. The process of claim 58, wherein said organometallic compound is dibutylmagnesium.

60. The process of claim 58, wherein said functionalized alkyllithium is 3-trimethylsilyloxy-1-propyllithium.

61. The process of claim 58, wherein said functionalized alkyllithium is 2,2-dimethyl-3-trimethylsilyloxy-1-propyllithium.

62. A process for preparing functionalized alkyllithium compositions having enhanced thermal stability, comprising:
reacting a functionalized alkylhalide with lithium to form a functionalized alkyllithium composition; and
adding dibutylmagnesium or a precursor thereof to said composition prior to, during or after the synthesis of said functionalized alkyllithium in an amount ranging from about 1 to about 7 mol %, based on the amount of alkyllithium species present.
